(19) United States
(12) Patent Application Publication
(10) Pub. No.: US 2026/0163138 A1
(43) Pub. Date: Jun. 11, 2026

(54) Battery Cell, and Battery Pack and Vehicle Including the Same

(71) Applicant: LG Energy Solution, Ltd., Seoul (KR)

(72) Inventors: Sung-Hwan Kim, Daejeon (KR); Do-Gyun Kim, Daejeon (KR); Ji-Wook Moon, Daejeon (KR); Myeong-Jun Jeon, Daejeon (KR); Gu-Jin Chung, Daejeon (KR); Min-Ki Jo, Daejeon (KR)

(73) Assignee: LG Energy Solution, Ltd., Seoul (KR)

(21) Appl. No.: 19/413,681

(22) Filed: Dec. 9, 2025

(30) Foreign Application Priority Data
Dec. 10, 2024 (KR) 10-2024-0182638

(51) Int. Cl. H01M 50/169; B60L 50/64; H01M 10/04; H01M 50/107; H01M 50/152; H01M 50/249

(52) U.S. Cl. CPC H01M 50/169; H01M 10/0431; H01M 50/107; H01M 50/152; H01M 50/249; B60L 50/64; H01M 2220/20

(57) ABSTRACT

A battery cell includes a wound electrode assembly, a battery housing accommodating the electrode assembly therein, and a housing lid. The battery housing has a sidewall and an open end defining an opening, where the housing lid is coupled to the open end so as to cover the opening. An interior surface of the sidewall along the open end has an inclined portion to guide press-fitting of the housing lid, in which the inclined portion is oriented obliquely relative to a central axis of the battery housing. The housing lid includes a radially outer side defining a facing surface that contacts the interior surface of the sidewall at the open end. The facing surface extends longer than the inclined portion along an axial direction of the battery housing.

### CROSS-REFERENCE TO RELATED APPLICATIONS

This application claims priority from Korean Patent Application No. 10-2024-0182638, filed on Dec. 10, 2024, the disclosure of which is incorporated herein in its entirety by reference.

### BACKGROUND

The present disclosure relates to a battery cell, and more specifically, to a battery cell having an improved assembly and bonding structure between a battery housing and a housing lid, as well as a battery pack and a vehicle including the battery cell.

Secondary batteries are attracting attention as a new energy source for better environmental friendliness and energy efficiency because they not only have the primary advantage of being able to drastically reduce the use of fossil fuels, but they also have the advantage of not generating any byproducts from energy use.

Cylindrical, rectangular, and pouch-shaped battery cells are widely known as types of secondary batteries. In the case of a cylindrical battery cell, a separator, which is an insulator, is interposed between elongated positive and negative electrodes, and that assembly is wound to form a jelly-roll type electrode assembly, which is then inserted into a housing together with an electrolyte to form a battery. Furthermore, strip-shaped electrode tabs may be connected to an uncoated portion of each of the positive and negative electrodes, and those electrode tabs electrically connect the electrode assembly to the electrode terminals exposed to the outside of the battery housing. For example, the positive electrode terminal may be provided by a cap of a sealing body that seals the opening of the housing, and the negative electrode terminal may be provided by the housing.

However, in conventional cylindrical batteries having such a structure, there are problems of high resistance, excessive heat generation, and poor current collection efficiency because the current is concentrated on the strip-type electrode tab that is coupled to the positive electrode uncoated portion and/or the negative electrode uncoated portion.

Resistance and heat generation are not major issues for small cylindrical batteries with form factors of 1865 or 2170. However, if the form factor is increased in order to utilize the cylindrical batteries as a power supplies in electric vehicles, the cylindrical batteries may ignite due to the excessive heat generated around the electrode tabs during rapid charging.

To solve these problems, a cylindrical battery (so-called tab-less cylindrical battery) has been proposed, which has a structure in which a positive electrode uncoated portion and a negative electrode uncoated portion are designed to be positioned at the top and bottom of a jelly-roll type electrode assembly, respectively, and a current collector plate is welded to the uncoated portions to improve current collection efficiency.

Meanwhile, a conventional cylindrical battery cell includes a beading portion and a crimping portion for assembling together the current collector, the battery housing, and the housing cover, as disclosed in, for example, Korean Unexamined Patent Publication No. 10-2024-0069584. As disclosed in that publication, the beading portion is deformed inwardly in the area between the open portion formed at one axial end of the battery housing and the accommodation portion that accommodates the electrode assembly. Also, the crimping portion extends upwardly from the beading portion and bends to surround the outer perimeter of the housing cover. A cylindrical battery having such a beading portion and crimping portion has advantages, such as the ability to easily fix the negative electrode current collector to the housing and the ability to ensure excellent airtightness between the battery housing and the housing cover. However, the process for forming the beading portion and the crimping portion requires precision, which is not a simple process. That may lead to frequent product defects during the beading process or the crimping fixing process, which may reduce production yield. Furthermore, cylindrical batteries with the beading portion and the crimping portion are disadvantageous in terms of energy density, as those structures take up space that is not capable of storing charge. Therefore, it may be beneficial to eliminate the beading and crimping portions from the battery housing and improve the sealing structure so that it is a simpler structure.

There have been examples of sealing a battery housing by welding and assembling the inner side of the open end of the battery housing and the outer side of the housing cover without the beading portion and the crimping portion. However, since the welding quality in such a process depends on the precise assembly between the open end of the battery housing and the housing cover, a method for reducing the assembly tolerances between the open end of the battery housing and the housing cover would be desirable.

### SUMMARY

### Technical Problem

The present disclosure provides a battery cell capable of improving the assembly between a battery housing and a housing lid.

The present disclosure also provides a battery cell capable of improving weldability between the battery housing and the housing lid and between the battery housing and the current collector plate.

The technical problems that the present disclosure seeks to solve are not limited to the above-mentioned problems, and other problems not mentioned above will be clearly understood by those skilled in the art from the description of preferred aspects of the invention provided below.

### Technical Solution

In one aspect of the present disclosure, there is provided a battery cell comprising: an electrode assembly, a battery housing accommodating the electrode assembly therein, and a housing lid. The electrode assembly includes a first electrode, a second electrode, and a separator interposed therebetween, all wound around a winding axis. The battery housing has a sidewall extending around a central axis between an open end and a closed end that oppose one another along the central axis, where the open end defines an opening into an interior space of the battery housing bounded by an interior surface of the sidewall. The housing lid is coupled to the open end of the battery housing so as to cover the opening. The interior surface of the sidewall along the open end has an inclined portion oriented obliquely relative to the central axis such that a cross-sectional area of the interior space of the battery housing defined orthogonally to the central axis decreases along the inclined portion away from the opening. The housing lid includes a radially outer side defining a facing surface that contacts the interior surface of the sidewall at the open end, where the facing surface extends longer than the inclined portion along an axial direction aligned along the central axis.

The open end may include a first axially-oriented portion of the interior surface; the inclined portion of the interior surface extending from an end of the first axially-oriented portion to the opening; a lateral portion extending in a radially outward direction relative to the central axis, the lateral portion extending from an end of the inclined portion at the opening to a radially outer end; and a second axially-oriented portion extending from the radially outer end of the lateral portion and defining an exterior surface of the sidewall.

The facing surface may include a first facing surface spaced from the inclined portion so as to define a gap between the inclined portion and the first facing surface; and a second facing surface facing and contacting the first axially-oriented portion.

A welding bead may be positioned in the gap between the inclined portion and the first facing surface.

As another example, the facing surface may include a first facing surface inclined to face and contact the inclined portion; and a second facing surface facing and contacting the first axially-oriented portion.

As still another example, the facing surface may include a first facing surface inclined along an angle relative to the central axis so as to face and contact the inclined portion; and a second facing surface positioned closer to the closed end than the first facing surface, the second facing surface extending along the same angle as the first facing surface.

The inclined portion may be configured to have an inclination angle relative to the central axis that decreases along the inclined portion away from the opening.

The inclined portion may have a height along the axial direction in a range from 0.1 mm to 0.4 mm.

A ratio of a height of the inclined portion along the axial direction and a length of the facing surface of the radially outer side of the lid along the axial direction may be in a range from 1:2.5 to 1:10.

The battery cell may further comprise a first current collector plate electrically connected to the first electrode inside the battery housing. Such first current collector plate may include a plate center portion contacting a first uncoated portion extending from the first electrode; a plate outer portion offset in the axial direction relative to the plate center portion so as to be spaced apart from the first uncoated portion, the plate outer portion extending radially outwardly from the plate center portion so as to contact the first axially-oriented portion of the interior surface; and a peripheral portion extending from a radially outer end of the plate outer portion in contact with the first axially-oriented portion, the peripheral portion extending toward the housing lid at an oblique angle relative to the central axis.

The battery cell may further comprise a welding filler interposed in an open space bounded by the first axially-oriented portion of the interior surface of the sidewall, the peripheral portion of the first current collector plate, and the housing lid, where the first axially-oriented portion, the peripheral portion, and the housing lid may be welded together by the welding filler.

The welding filler may be a metal material with a lower melting point than the battery housing, the first current collector plate, and the housing lid.

The welding filler may be fixed inside the battery housing so as to prevent the housing lid from advancing further into the battery housing along the axial direction.

The battery cell may further comprise a first current collector plate disposed between the electrode assembly and the housing lid inside the battery housing and electrically connected to the first electrode, where the housing lid may have an electrolyte injection hole at a center thereof, where the first current collector plate may have a center hole aligned with the electrolyte injection hole along the central axis, and where a cavity at a winding core center of the electrode assembly is aligned with the center hole along the central axis.

The radially outer side of the housing lid may be define a ‘U’ shape.

The housing lid may include a lid center portion positioned radially inwardly from the radially outer side of the lid, where the lid center portion is in direct contact with a first uncoated portion extending from the first electrode.

As another example, the housing lid may include a lid core portion positioned at a central portion of the housing lid in a radial direction with respect to the central axis, where the lid core portion may define a convex surface facing the electrode assembly, such convex surface being arranged to be spaced apart from the first uncoated portion in the axial direction; and an electrode contact portion positioned between the lid core portion and the radially outer side of the lid in the radial direction, where the electrode contact portion may be in direct contact with the first uncoated portion in the axial direction.

The electrode contact portion may be divided into three regions spaced apart from one another in a circumferential direction about the central axis.

The lid core portion may have an electrolyte injection hole formed therethrough along the axial direction, the housing lid may further include a plug cap that covers the electrolyte injection hole, and the plug cap may include a cap outer portion overlying a surface of the lid core portion extending around a periphery of the electrolyte injection hole, and a cap center portion protruding from the cap outer portion through the electrolyte injection hole along the axial direction and into the battery housing.

A radially outer edge of the cap outer portion may be spaced radially away from a radially outer edge of the electrolyte injection hole by a distance in a range from 1.5 mm to 3.5 mm, and the cap outer portion and the lid core portion may be welded together.

In another aspect of the present disclosure, there is also provided a battery pack comprising the battery cell described above.

In still another aspect of the present disclosure, there is also provided a vehicle comprising the battery pack.

### Advantageous Effects

According to one aspect of the present disclosure, a battery cell having improved assembly between a battery housing and a housing lid may be provided.

According to another aspect of the present disclosure, a battery cell having improved weldability between a battery housing and a housing lid and between a battery housing and a current collector plate may be provided.

The effects that can be obtained through the present disclosure are not limited to the above effects, and other technical effects not mentioned herein may be clearly understood by those skilled in the art from the following disclosure.

### DESCRIPTION OF DRAWINGS

The accompanying drawings illustrate some preferred aspects of the present disclosure. Together with the foregoing disclosure, the drawings serve to provide further understanding of the technical features of the present disclosure, but the present disclosure is not construed as being limited to the specific details illustrated in the drawings.

FIG. 1 is a perspective view showing a battery cell according to a first aspect of the present disclosure.

FIG. 2 is an inverted perspective view showing the battery cell of FIG. 1 from the other side.

FIG. 3 is a cross-sectional elevation view showing an electrode assembly, a first current collector plate, and a second current collector plate according to the first aspect of the present disclosure.

FIG. 4 is a partially exploded perspective view showing main components of the battery cell according to the first aspect of the present disclosure.

FIG. 5 is a cross-sectional view showing the battery cell components of FIG. 2.

FIG. 6 is a partial enlarged view of FIG. 3.

FIG. 7 is an enlarged view showing portion A of FIG. 6.

FIG. 8 is a perspective view of a welding filler according to the first aspect of the present disclosure.

FIG. 9 is an enlarged cross-sectional view of a portion of a battery cell according to a second aspect of the present disclosure, illustrating a portion corresponding to that in FIG. 7.

FIG. 10 is a partial cross-sectional view illustrating assembly of a housing lid with a battery housing according to a third aspect of the present disclosure.

FIG. 11 is a partial cross-sectional view of the assembled housing lid and battery housing of FIG. 10.

FIG. 12 is a partial cross-sectional view of the assembled housing lid and battery housing of the battery cell according to a fourth aspect of the present disclosure.

FIG. 13 is a partial cross-sectional view of the assembled housing lid and battery housing of a battery cell according to a fifth aspect of the present disclosure.

FIG. 14 is an enlarged view of a portion of FIG. 13.

FIG. 15 is a view showing a welding bead after welding between the battery housing and the housing lid in FIG. 14.

FIG. 16 is a cross-sectional view showing a portion of a battery cell according to a sixth aspect of the present disclosure.

FIG. 17 is a perspective cross-sectional view of the battery cell of FIG. 16.

FIG. 18 is a perspective view of the housing lid of FIG. 17.

FIG. 19 is a partially cut-away perspective view illustrating an example of a battery pack including a plurality of battery cells according to the present disclosure.

FIG. 20 is a perspective diagrammatic illustration of a vehicle including the battery pack of FIG. 19.

### BEST MODE

Hereinafter, preferred embodiments of the present disclosure will be described in detail with reference to the accompanying drawings. It should be understood that the terms used in the specification and the appended claims should not be construed as being limited to general and dictionary meanings, but rather are to be interpreted based on the meanings and concepts conveyed by the technical aspects of the present. In that regard, the following description merely represents some preferable examples for the purpose of illustration only, and it is not intended to limit the scope of the disclosure. It is to be understood that other equivalents and modifications could be made to the examples disclosed herein without departing from the scope of the disclosure.

Furthermore, the accompanying drawings are not drawn to scale, and the dimensions of some components may be exaggerated for illustrative purposes. In addition, the same reference signs may be assigned to the same components in different embodiments.

Terms used herein that indicate directions, such as “upper,” “lower,” “left,” “right,” “front,” “rear,” etc. may be used in the present disclosure, but it is to be understood to those skilled in the art that these terms are only for convenience in distinguishing different directions relative to one another and may vary depending on the location of a target object or the location of an observer. That is, as used herein (including in the claims), the various directions are not to be limited to having particular orientations with respect to a gravitational frame of reference, but rather the directions are labeled for convenience in distinguishing different directions relative to one another.

Hereinafter, a battery cell is explained as having a cylindrical shape that accommodates a jelly-roll type electrode assembly therein. In the following description, a height direction of the cylindrical battery cell may be referred to as the axial direction. In addition, a circumferential direction that encircles an imaginary centerline passing through the center of the cylindrical battery cell along the height/axial direction may be referred to as the circumferential direction or the peripheral direction. In addition, the direction both approaching and moving away from the centerline may be referred to as the radial direction. Moreover, the direction approaching the centerline along the radial direction may be particularly referred to as a centripetal direction, and the direction moving away from the centerline along the radial direction may be referred to as a centrifugal direction.

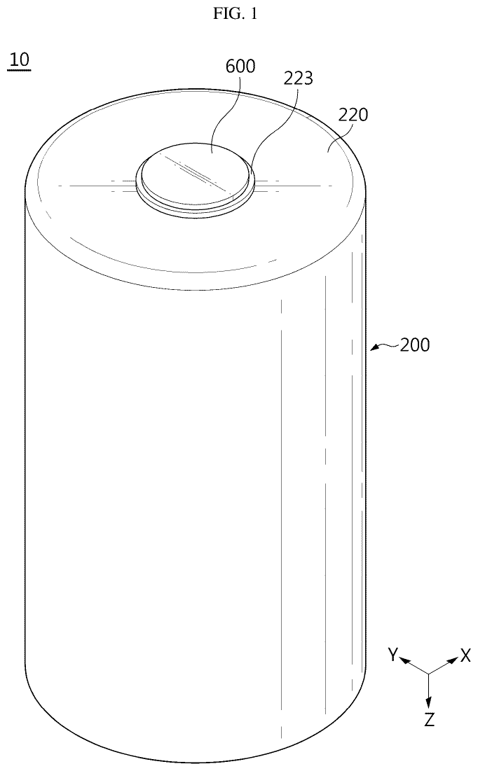

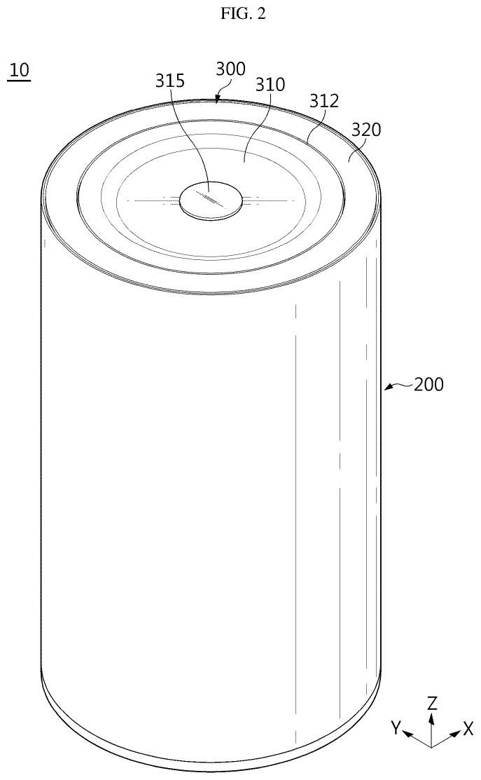

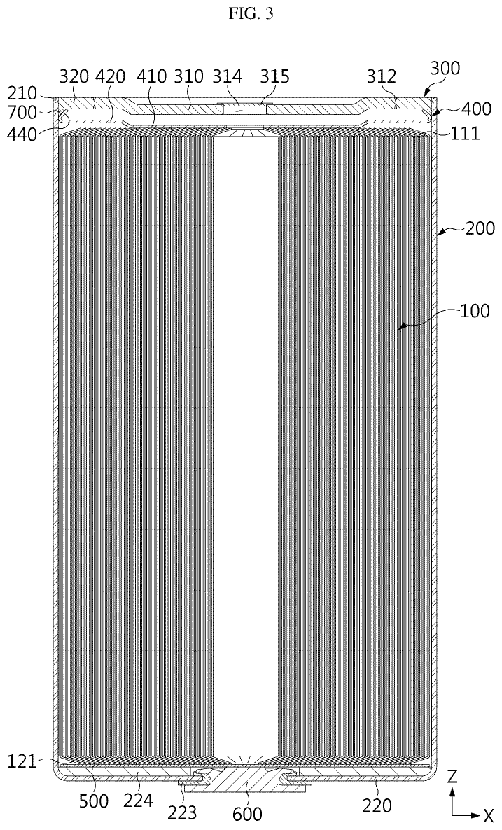

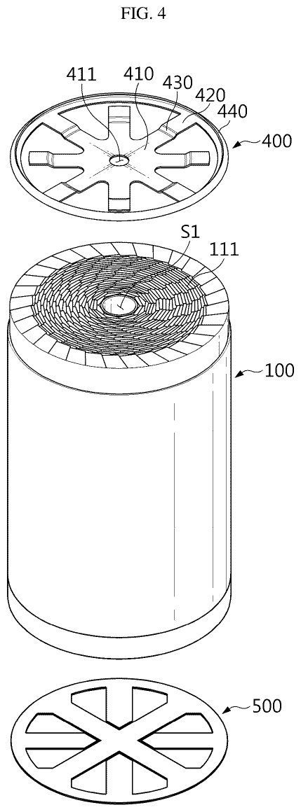

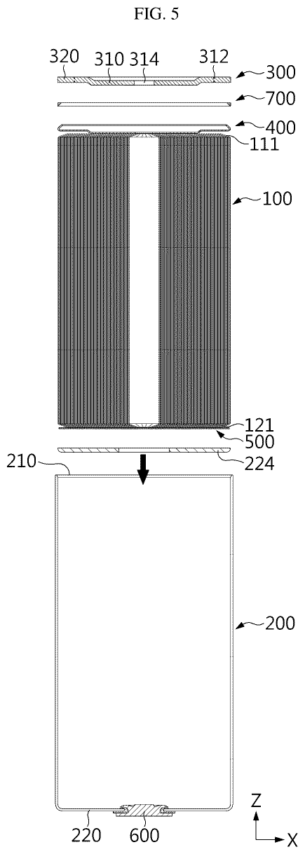

FIG. 1 is a perspective view showing a battery cell according to a first aspect of the present disclosure; FIG. 2 is an inverted perspective view showing the battery cell of FIG. 1 from the other side; FIG. 3 is a cross-sectional elevation view showing an electrode assembly, a first current collector plate, and a second current collector plate according to the first aspect of the present disclosure; FIG. 4 is a partially exploded perspective view showing main components of the battery cell according to the first aspect of the present disclosure; and FIG. 5 is a cross-sectional view showing the battery cell components of FIG. 2.

Referring to such drawings, the battery cell 10 according to the first aspect of the present disclosure includes an electrode assembly 100, a battery housing 200, and a housing lid 300.

The electrode assembly 100 includes a first uncoated portion 111 and a second uncoated portion 121. Specifically, the electrode assembly 100 has a structure in which a first electrode, a second electrode, and a separator interposed therebetween are wound around a winding axis to define a core and an outer circumference.

The electrode assembly 100 applied to the present disclosure may be a jelly-roll type electrode assembly 100. In this case, an additional separator may be provided on the outer circumference of the electrode assembly 100 for insulation from the battery housing 200. The electrode assembly 100 may have, without limitation, a winding structure well known in the art.

The first electrode includes a first electrode current collector and a first electrode active material applied on one or both sides of the first electrode current collector. An uncoated portion on which the first electrode active material is not applied exists along at least a portion of one side in the width direction (i.e., the Z direction parallel to the height direction of the battery cell 10 shown in FIG. 3) of the first electrode. That is, in accordance with some aspects of this disclosure, the first electrode includes an uncoated portion on which the active material is not coated that extends along a longitudinal side of the first electrode in the winding direction and which may be arranged so as to be exposed outwardly beyond an edge of the separator. The uncoated portion functions as an electrode tab of the first electrode and is hereinafter referred to as a first uncoated portion 111. The first uncoated portion 111 is provided along the upper side in the height direction (i.e., the Z direction parallel to the height direction of the battery cell 10 shown in FIG. 3) of the electrode assembly 100 accommodated in the battery housing 200. That is, the first electrode includes a first uncoated portion 111, which is not coated with an active material layer, along a longitudinal side of the first electrode, and the first uncoated portion 111 is exposed outside of the separator, such that at least a part of the first uncoated portion 111 is itself used as an electrode tab. The first uncoated portion 111 may be, for example, a negative electrode tab.

At least a part of the first uncoated portion 111 may include a plurality of segments divided along the winding direction of the electrode assembly 100. In this case, the plurality of segments may be bent along the radial direction of the electrode assembly 100, e.g., bent so as to be oriented radially inwardly towards the core of the electrode assembly 100, as shown in FIG. 3. The plurality of bent segments may be overlapped in multiple layers. A first current collector plate 400 may be disposed on the upper portion of the first uncoated portion 111. For example, the first uncoated portion 111 and the first current collector plate 400 may be in contact, and at least a part of each of those components may be welded to one another at the contacted portion.

The second electrode includes a second electrode current collector and a second electrode active material coated on one or both sides of the second electrode current collector. An uncoated portion on which the second electrode active material is not coated exists along at least a portion of the other side of the second electrode current collector in the width direction (parallel to the Z-axis). That is, the uncoated portion of the second electrode may be positioned along an opposite side of the electrode assembly 100 in the width direction from the position of the first uncoated portion 111 of the first electrode. The uncoated portion of the second electrode functions as an electrode tab of the second electrode and is hereinafter referred to as a second uncoated portion 121. The second uncoated portion 121 is located along the lower portion of the electrode assembly 100 accommodated in the battery housing 200 in FIG. 3. That is, the second electrode current collector includes a second uncoated portion 121, on which an active material layer is not coated, along a longitudinal side of the second electrode, and the second uncoated portion 121 is exposed outwardly beyond an edge of the separator such that at least a part of the second uncoated portion 121 is itself used as an electrode tab. The second uncoated portion 121 may be, for example, a positive electrode tab.

At least a part of the second uncoated portion 121 may include a plurality of segments divided along the winding direction of the electrode assembly 100, similar to the first uncoated portion 111 described above. In this case, the plurality of segments may similarly be bent along the radial direction of the electrode assembly 100. The plurality of bent segments may be overlapped in multiple layers. A second current collector plate 500 may be disposed at the lower portion of the second uncoated portion 121. For example, the second uncoated portion 121 and the second current collector plate 500 may be connected by welding.

The first uncoated portion 111 and the second uncoated portion 121 extend in opposite directions along the height direction of the battery (the direction parallel to the Z-axis). The first uncoated portion 111 extends toward the open end 210 of the battery housing 200, and the second uncoated portion 121 extends toward the closed portion 220 located opposite the open end 210.

As shown in FIGS. 4 and 5, the battery housing 200 may be configured to accommodate the electrode assembly 100 therein. The battery housing 200 is a generally cylindrical receiver having an open end 210 formed at one side, and is made of a conductive material such as metal. As a material for the battery housing 200, steel, stainless steel, nickel-plated iron, etc. may be used.

Specifically, the battery housing 200 may include a cylindrical sidewall extending around a central axis (oriented along the Z-axis direction), a flat closed portion 220 connected to one end (i.e., a closed end) of the sidewall in the height direction (Z direction), and an open end 210 provided at the other end of the sidewall in the height direction. The end of the sidewall that is not connected to the closed portion 220 may define an opening into an interior space of the battery housing 200 and may be referred to as the open end 210 of the battery housing 200. The sidewall and the closed portion 220 may be manufactured by, for example, performing a deep drawing process on a metal sheet having a nickel-plated surface of steel, and then trimming the front end of the sidewall forming the open end 210 with a punch while holding the front end of the sidewall with a holder.

The battery housing 200 may accommodate the electrode assembly 100 in the interior space thereof by inserting the electrode assembly 100 through the open end 210. In directions orthogonal to the central axis, the interior space may be bounded by an interior surface of the sidewall. The electrode assembly 100 may be accommodated inside the battery housing 200 such that the first uncoated portion 111 faces the open end 210 and the second uncoated portion 121 faces the closed portion 220.

The battery housing 200 may be electrically connected to the first electrode of the electrode assembly 100. As shown in FIG. 5, the first uncoated portion 111 extending from the first electrode is configured to contact the first current collector plate 400, and the first current collector plate 400 is configured to contact the battery housing 200, so that the battery housing 200 may be electrically connected to the first electrode. Thus, the battery housing 200 will have the same polarity as the first uncoated portion 111.

The closed portion 220 of the battery housing 200 includes a cell terminal 600 that is insulated from the battery housing 200 and electrically connected to the second electrode. The cell terminal 600 is made of a conductive metal material. For example, aluminum (Al) may be used as the material of the cell terminal 600. For example, as shown in FIG. 5, the second uncoated portion 121 may be connected to the second current collector plate 500, and the second current collector plate 500 may be connected to the cell terminal 600, which is arranged to pass through the closed portion 220 in the axial direction. Accordingly, the cell terminal 600 is electrically connected to the second electrode of the electrode assembly 100 and has the same second polarity as the second electrode. Alternatively, in a different aspect, the cell terminal 600 may be configured to be electrically connected to the first electrode and electrically insulated from the battery housing 200 having the first polarity.

Electrical insulation between the cell terminal 600 and the battery housing 200 may be achieved in various ways. For example, insulation may be achieved by interposing an insulator 224 between the second current collector plate 500 and the closed portion 220 of the battery housing 200 and interposing an insulating gasket 223 between the cell terminal 600 and the battery housing 200. Alternatively, insulation may be achieved by forming an insulating coating layer on a part of the cell terminal 600. Alternatively, a method may be used in which the cell terminal 600 is rigidly fixed with respect to the battery housing 200 while preventing any electrical contact between the cell terminal 600 and the battery housing 200. In an even further alternative, several of the methods described above may be utilized together.

Meanwhile, the housing lid 300 may be coupled and sealed to the open end 210 of the battery housing 200.

The housing lid 300 according to this aspect may have a vent notch 312 configured to rupture when the pressure inside the battery housing 200 exceeds a threshold value. For example, the vent notch 312 may be formed on both sides of the housing lid 300 (i.e., the inside surface and the outside surface), and the vent notch 312 may be formed in at least one pattern selected from: a continuous circular pattern, a discontinuous circular pattern, and a linear pattern on the surface of the housing lid 300. Also, the vent notch 312 may be formed in various other patterns.

In addition, the housing lid 300 may have an electrolyte injection hole 314 at its center. The electrolyte injection hole 314 may be aligned with a cavity S1 formed in the Z-axis direction along the winding core center of the electrode assembly 100. In addition, the first current collector plate 400 may have a center hole 411 provided at its center and aligned with the electrolyte injection hole 314.

For example, after the housing lid 300 is coupled to the open end 210 of the battery housing 200, the electrolyte may be injected into the battery housing 200 through the electrolyte injection hole 314 and the center hole 411. The electrolyte injection hole 314 may be closed after the electrolyte injection is completed. For example, the electrolyte injection hole 314 may be sealed with a lid hole cap 315 provided in the form of a metal disc. As an alternative to this aspect, the electrolyte injection hole 314 may be sealed by pressing-fitting a ball (not shown) into the electrolyte injection hole 314. In this case, welding may be performed or an adhesive may be applied to the contact interface between the ball and the electrolyte injection hole 314. Alternatively, in contrast to this aspect, the electrolyte injection may be applied by making a terminal hole in the cell terminal 600 provided in the closed portion 220 of the battery housing 200, injecting the electrolyte, and then closing the terminal hole. In such case, the lid hole cap 315 and the electrolyte injection hole 314 may be omitted from the housing lid 300.

In the battery cell 10 according to the present disclosure, the open end 210 has an inclined portion 212 that is obliquely oriented relative to the Z-axis or height direction of the battery, so as to guide the forced fitting of the housing lid 300. That inclined portion 212 may take the form of a chamfer formed along the inner edge of the cylindrical sidewall at the open end 210. In addition, the housing lid 300 includes a radially outer side 320 having facing surfaces 321, 322 that face the interior surface of the open end 210, and the facing surfaces 321, 322 are provided to extend longer in the axial direction (Z direction) of the battery housing 200 than the height of the inclined portion 212.

As will be explained in detail later, this configuration may increase the assembly convenience and airtightness between the open end 210 of the battery housing 200 and the housing lid 300 after forced fitting, and it may also reduce alignment errors. Accordingly, the welding quality of the battery housing 200 and the housing lid 300 may be improved.

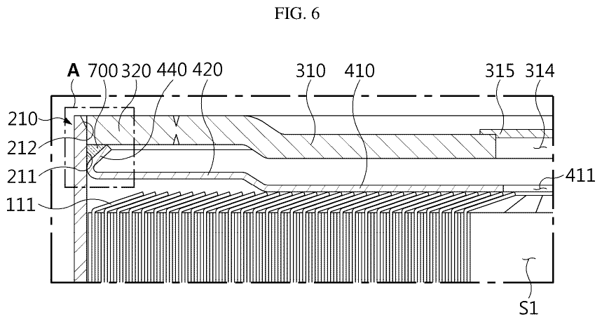

Specifically, the housing lid 300 according to this aspect is provided in an approximately circular disc shape, and its diameter is provided to correspond to the inner diameter of the battery housing 200. As shown in FIGS. 5 and 6, the housing lid 300 includes a lid center portion 310 extending in the radial direction from its center and a radially outer side 320 positioned outside the lid center portion 310 in the radial direction, where the radially outer side 320 is offset in the axial direction from the lid center portion 310.

The housing lid 300 may be configured to be press-fitted into the open end 210 of the battery housing 200 such that at least a part of the radially outer side 320 comes into contact with the interior surface of the open end 210.

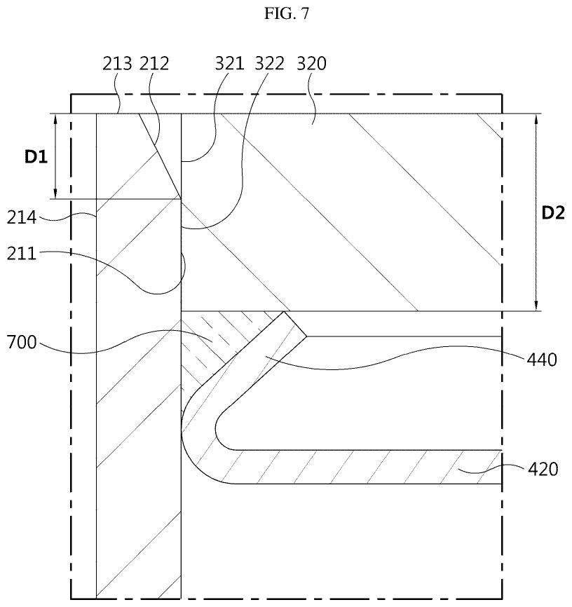

The open end 210 includes, as shown in FIG. 7, a first vertical (or axially-oriented) portion 211 forming a part of the interior surface, an inclined portion 212 forming the remaining part of the interior surface and extending obliquely from an upper end of the first vertical portion 211 toward the outer (or exterior) surface, a horizontal (or lateral) portion 213 extending in a radially outward direction relative to the central axis from an end of the inclined portion 212 toward the outer surface, and a second vertical portion 214 connected to a radially outer end of the horizontal portion 213 and forming the exterior surface of the sidewall.

In addition, the radially outer side 320 of the housing lid 300 is arranged so that the facing surfaces 321, 322 extend along the axial direction (Z direction) in such a way that its length D2 along the axial direction is greater than the height D1 of the inclined portion 212 along the axial direction.

According to this configuration, when the housing lid 300 is press-fitted into the open end 210, the radially outer side 320 may be easily inserted inwardly into the battery housing 200 due to the guidance along the inclined surface of the inclined portion 212. In addition, the open end 210 and the housing lid 300 may be easily aligned so that the first horizontal portion 213 of the open end 210 and the upper surface of the radially outer side 320 are located along the same plane.

In more detail, for example, when the housing lid 300 is inserted into the battery housing 200 in a state where the open end 210 does not have the inclined portion 212 as in this aspect, if the first vertical portion 211 of the open end 210 and the side surface of the radially outer side 320 are even slightly misaligned in the radial direction, it is difficult to insert the housing lid 300 into the battery housing 200. Then, if the housing lid 300 is pushed in excessively, damage and deformation of the open end 210 may occur. However, according to this aspect, if the first vertical portion 211 of the open end 210 and the side of the radially outer side 320 are slightly misaligned just before inserting the housing lid 300 into the battery housing 200, the lower end of the radially outer side 320 may be guided along the inclined surface of the inclined portion 212 during the process of pushing the housing lid 300 into the battery housing 200, thereby causing the first vertical portion 211 of the open end 210 and the facing surfaces 321, 322 of the radially outer side 320 to come into contact.

In addition, since the radially outer side 320 is thicker along the axial direction (Z direction) than the height of the inclined portion 212 of the open end 210 in this aspect, the insertion depth of the housing lid 300 may be adjusted so that the heights of the horizontal portion 213 of the open end 210 and the upper surface of the radially outer side 320 are aligned at the same level in a state where the first vertical portion 211 of the open end 210 and the side surface of the radially outer side 320 are in contact with each other.

That is, the facing surfaces 321, 322 of the radially outer side 320 according to this aspect may include a first facing surface 321 that is spaced apart from the inclined portion 212 and provided to have a predetermined gap between the inclined portion 212 and the first facing surface 321, and a second facing surface 322 that is provided to face and contact the first vertical portion 211, as shown in FIG. 7.

If the housing lid 300 is assembled to the open end 210 with the structure as described above, there is almost no gap between the first vertical portion 211 and the second facing surface 322. In this state, the first vertical portion 211 and the second facing surface 322 may be strongly coupled by performing, for example, laser welding targeted to the gap between the inclined portion 212 and the first facing surface 321. By performing laser welding to the gap in this way, the amount of the welding bead protruding outside the gap may be reduced. That is, according to this aspect, the welding bead preferably fills the gap defined between the inclined portion 212 and the first facing surface 321, so that there is almost no change in the total height of the battery cell. For reference, in this aspect, the height of the inclined portion 212 provided at the open end 210 may be in a range from 0.1 mm to 0.4 mm.

The ratio of the height (D1) of the inclined portion and the length (D2) of the facing surface of the radially outer side may be in a range from 1:2.5 to 1:10, and may preferably be 1:5.

For example, if the height (D1) of the inclined portion is excessively large, the laser may be irradiated deep into the battery housing during laser welding, increasing the risk of damage to the electrode assembly and/or the first current collector plate. To reduce this risk of damage to the electrode assembly and/or the first current collector plate, the thickness of the housing lid along the axial direction may be increased more than the height of the inclined portion along that direction. However, as the thickness of the housing lid that is forcibly fitted into the battery housing increases, the interior space of the battery housing decreases, which leads to the disadvantage of reduced energy density. Accordingly, in the battery cell according to the present disclosure, as example values that can minimize the risk of damage to the electrode assembly and/or the first current collector plate due to laser welding without reducing the energy density, the height (D1) of the inclined portion 212 may be 0.2 mm and the length (D2) of the facing surfaces 321, 322 together may be 1 mm.

Meanwhile, referring to FIGS. 3 and 5 to 8 again, the battery cell 10 according to this aspect further includes a welding filler 700 to ensure reliability of the electrical connection between the battery housing 200 and the first current collector plate 400. The welding filler 700 may be placed in an area where the edge of the first current collector plate 400 and the interior surface of the battery housing 200 come into contact.

Specifically, the first current collector plate 400 according to this aspect includes a plate center portion 410, a plate outer portion 420, an inclined connection portion 430 connecting the plate center portion 410 and the plate outer portion 420, and a peripheral or edge bent portion 440.

The plate center portion 410 may be in contact with the first uncoated portion 111 and may be coupled to the first uncoated portion 111 by, for example, laser welding or ultrasonic welding. The plate outer portion 420 may be offset in the axial direction from the plate center portion 410 so as to be spaced apart from the first uncoated portion 111, and may be provided to extend radially outwardly so as to contact the first vertical portion 211 of the open end 210. In addition, the edge bent portion 440 may extend obliquely toward the radially outer side 320 from the end of the plate outer portion 420 that is in contact with the first vertical portion 211.

In one aspect of the present disclosure, the edge bent portion 440 forms a predetermined angle with the first vertical portion 211. The predetermined angle may be an acute angle. For example, the predetermined angle may be in a range from 30° to 60°. Due to the formation of the angle, a surplus space may be formed between the edge bent portion 440 and the first vertical portion 211. A welding filler 700 may be interposed in that surplus space. By melting the welding filler 700 during welding between the first current collector plate 400 and the battery housing 200, even if a gap were to exist between the first current collector plate 400 and the interior surfaces of the battery housing 200, the first current collector plate 400 and the battery housing 200 may nevertheless be smoothly coupled.

The welding filler 700 may be interposed in the surplus space surrounded by the edge bent portion 440 of the first current collector plate 400, the first vertical portion 211 of the open end 210, and the radially outer side 320 of the housing lid 300. The welding filler 700 may be provided in a shape that conforms to the surplus space. By heat-melting the welding filler 700, the first vertical portion 211, the edge bent portion 440 and the radially outer side 320 may become integrally coupled together.

The welding filler 700 may be made of a metal material having an electrical conductivity, and a melting point of the welding filler 700 may be lower than that of the battery housing 200, the second current collector plate 500, and the housing lid 300. By using the filler metal, since the welding filler 700 melts at a temperature lower than the melting temperatures of the battery housing 200, the first current collector plate 400, and the housing lid 300, triple welding is possible for the battery housing 200, the first current collector plate 400, and the housing lid 300 with low output.

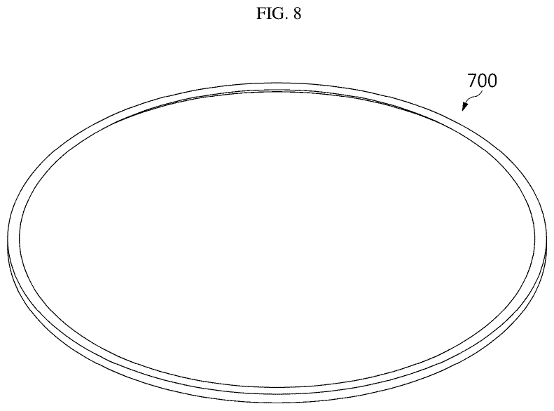

The welding filler 700 may be positioned inside the battery housing 200 to limit the depth at which the housing lid 300 is inserted into the battery housing 200. For example, the welding filler 700 is positioned in the surplus space formed by the first vertical portion 211 of the open end 210 and the bent portion of the first current collector plate 400. Here, the welding filler 700 may be provided in a ring shape, as shown in FIG. 8. According to this configuration, when the housing lid 300 is inserted into the battery housing 200, if a predetermined depth is reached, the lower surface of the radially outer side 320 comes into contact with the upper surface of the welding filler 700. In this way, if the insertion depth of the housing lid 300 is limited, the assembly tolerance between the housing lid 300 and the open end 210 of the battery housing 200 may be reduced.

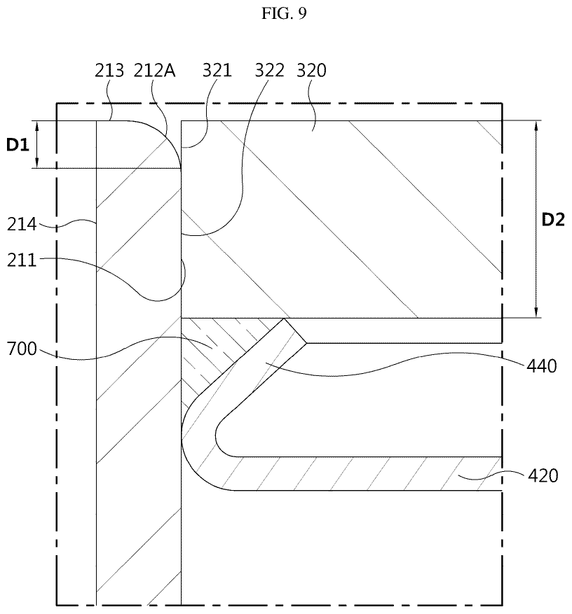

Next, with reference to FIGS. 9 to 12, the battery cell 10 according to other aspects of the present disclosure will be described.

The same reference numerals as in the former drawings represent the same parts, and such corresponding parts will not be described in detail, whereas features different from the former aspect will be mainly explained in more detail below.

FIG. 9 is an enlarged cross-sectional view like that of FIG. 7, except showing a battery cell 10 according to a second aspect of the present disclosure.

In the case of the battery cell according to the second aspect of the present disclosure, the inclined portion 212A of the open end 210 may be formed as a curved surface. As shown in FIG. 9, the inclined portion 212A may be configured such that the inclination thereof increases in a direction along which the radially outer side 320 is inserted. In other words, the inclination angle relative to the central axis decreases along the inclined portion 212A away from the opening at the open end 210. In this case, compared to the first aspect described above, it is advantageous in that the overall height of the inclination along the axial direction is reduced, and the contact area between the first vertical portion 211 and the second facing surface 322 is larger, so that the sealing between the housing lid 300 and the battery housing 200 may be further strengthened.

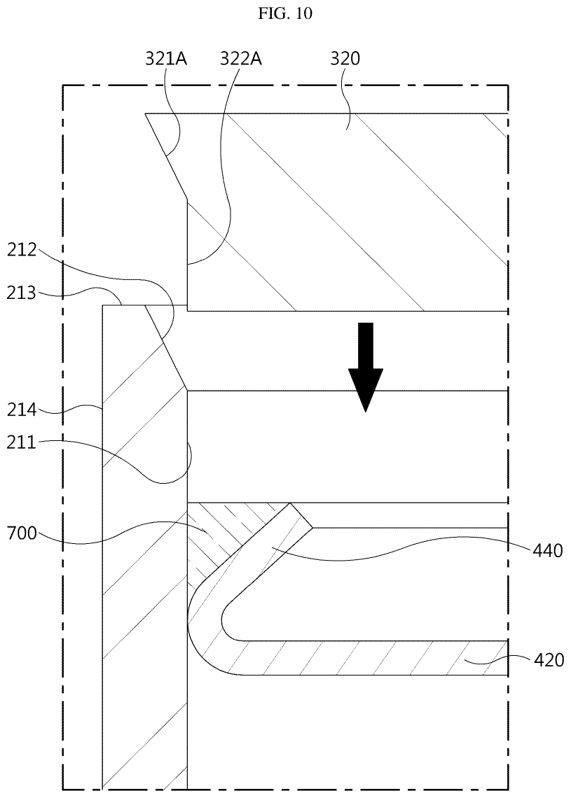

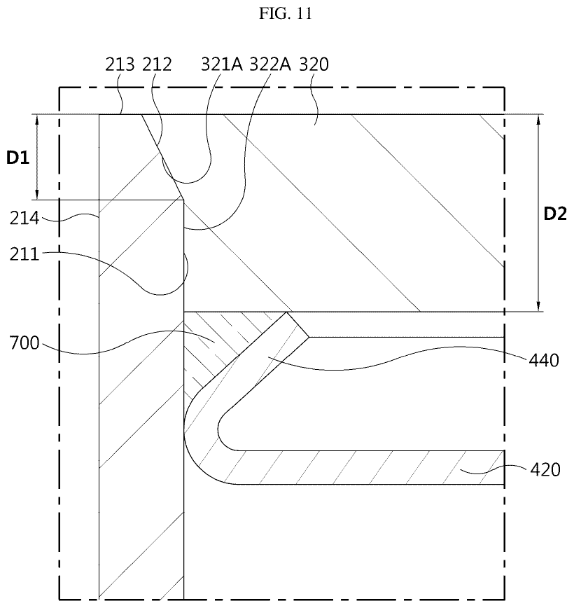

FIG. 10 is a partial cross-sectional view illustrating assembly of a housing lid with a battery housing according to a third aspect of the present disclosure, and FIG. 11 is a partial cross-sectional view of the assembled housing lid and battery housing of FIG. 10.

The radially outer side 320 of the housing lid 300 according to the third aspect of the present disclosure includes a first facing surface 321A that is inclined to face and contact the inclined portion 212 of the open end 210, and a second facing surface 322A that is arranged to face and contact the first vertical portion 211.

As shown in FIGS. 10 and 11, when the housing lid 300 is seated in the open end 210 of the battery housing 200, the second facing surface 322A of the radially outer side 320 may be guided to be inserted to the correct position by the inclined portion 212 of the open end 210, and the first facing surface 321A of the radially outer side 320 may face and contact the inclined portion 212. In this case, the gap between the radially outer side 320 of the housing lid 300 and the open end 210 of the battery housing 200 is minimized and the contact area is maximized, so that the sealing between the housing lid 300 and the battery housing 200 may be further strengthened during welding.

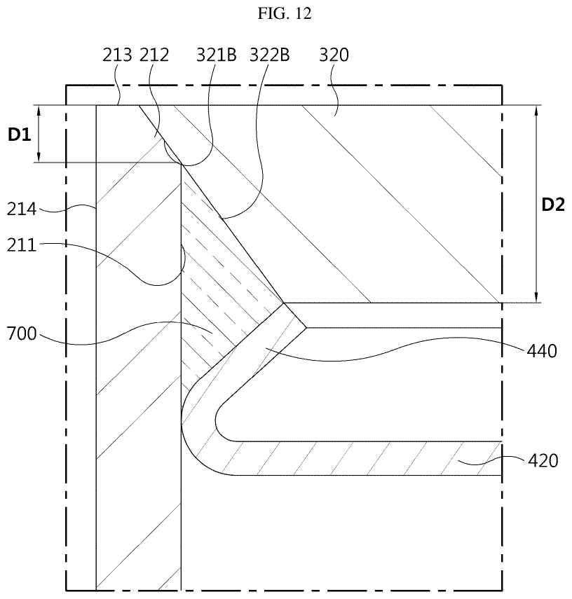

FIG. 12 is a partial cross-sectional view of the assembled housing lid and battery housing of the battery cell 10 according to a fourth aspect of the present disclosure.

The radially outer side 320 of the housing lid 300 according to the fourth aspect of the present disclosure includes a first facing surface 321B that is inclined to face and contact the inclined portion 212 of the open end 210 and a second facing surface 322B that extends below the first facing surface 321B and continues at the same angle as the first facing surface 321B downwardly into the battery housing 200.

That is, as shown in FIG. 12, the first facing surface 321B and the second facing surface 322B of the radially outer side 320 are arranged to extend at the same angle. In this case, if the housing lid 300 is placed at the open end 210 so that the first facing surface 321B and the inclined portion 212 of the open end 210 face and contact each other, the radially outer side 320 may no longer move downwardly into the battery housing 200. Therefore, the housing lid 300 and the open end 210 may be aligned more easily. Meanwhile, according to the fourth aspect, a gap exists between the first vertical portion 211 of the open end 210 and the second facing surface 322B of the radially outer side 320. The gap may be filled with a welding filler 700. That is, in the fourth aspect, the welding filler 700 may be interposed in the surplus space surrounded by the first vertical portion 211, the bent portion of the first current collector plate 400, and the second facing surface 322B. In this case, the welding filler 700 may be thermally melted so that the battery housing 200, the housing lid 300, and the first current collector plate 400 are integrally coupled together.

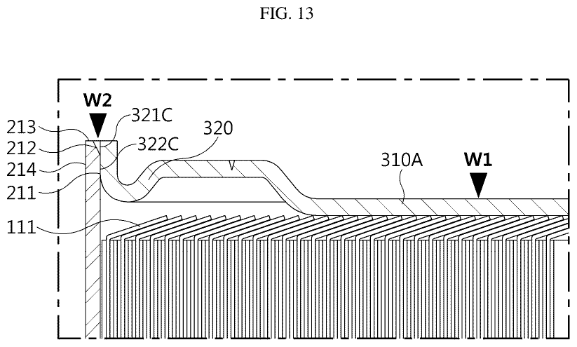

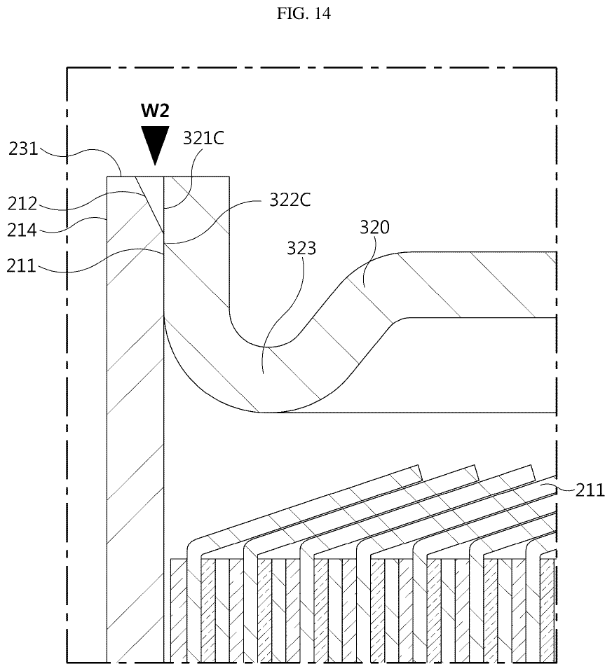

FIG. 13 is a partial cross-sectional view of the assembled housing lid and battery housing of a battery cell according to a fifth aspect of the present disclosure, FIG. 14 is an enlarged view of a portion of FIG. 13, and FIG. 15 is a view showing a welding bead after welding between the battery housing and the housing lid in FIG. 14.

As shown in FIG. 13, the housing lid 300 according to the fifth aspect of the present disclosure may be configured to be directly coupled to the first uncoated portion 111 without the first current collector plate 400.

If the housing lid 300 is press-fitted into the battery housing 200, the housing lid 300 may be press-fitted to a position where, for example, the bottom surface (inner surface in the axial direction) of the lid center portion 310A is in close contact with the first uncoated portion 111 of the electrode assembly 100. As indicated by W1 in FIG. 13, the first uncoated portion 111 may be coupled to the housing lid 300 by welding. The welding may be performed by a laser that irradiates the axial upper surface of the lid center portion 310A from outside the battery housing 200 along the axial direction. The laser may be irradiated by scanning along the radial direction to form a welding portion that extends longitudinally in the radial direction. In this case, the housing lid 300 may function as a cover that closes the open end 210 of the battery housing 200 and may also function as the first current collector plate 400 as in the former aspects.

In addition, as shown in FIGS. 13 and 14, the radially outer side 320 may include a facing surface 321C, 322C, followed by a curved surface 323, moving from the radially outer side towards the radially inner side. The facing surface 321C, 322C and the curved surface 323 may be configured to define an approximately U-shape.

The housing lid 300 with its radially outer side 320 defining a U-shape may be particularly suitable for being press-fitted into the open end 210 of the battery housing 200. That is, the curved surface 323 provides a cross-sectional shape that allows the housing lid 300 to be elastically deformed inwardly in the radial direction. Accordingly, when the housing lid 300 is press-fitted into the open end 210, the U-shaped radially outer side 320 may be compressed radially inwardly while the U-shaped curved surface 323 acts like a spring, biasing the facing surface 321C, 322C radially outwardly so as to firmly press the housing lid 300 against the open end 210 while minimizing deformation of other parts of the housing lid 300 as much as possible. Accordingly, a radial sealing force may result between the first vertical portion 211 of the open end 210 and at least the second facing surface 322C. In other words, when the housing lid 300 is press-fitted into the open end 210 of the battery housing 200, the facing surface 321C, 322C may be strongly pressed into contact with the first vertical portion 211 without being distorted.

The battery cell according to the present disclosure includes a welding bead WB provided in a predetermined gap formed between the inclined portion of the open end and the first facing surface of the housing lid. As described above, by performing laser welding W2 in the gap between the inclined portion 213 of the open end 210 and the first facing surface 321C of the radially outer side 320, the amount of the welding bead WB protruding upwardly out of the gap along the axial direction may be reduced, as shown in FIG. 15. That is, the welding bead WB generated when welding the housing lid 300 to the open end 210 of the battery housing 200 fills the gap, so that the overall height of the battery cell is not substantially changed.

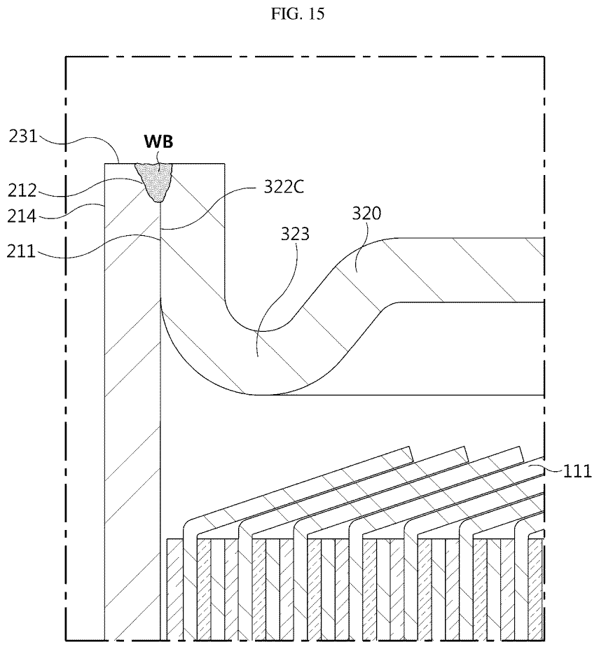

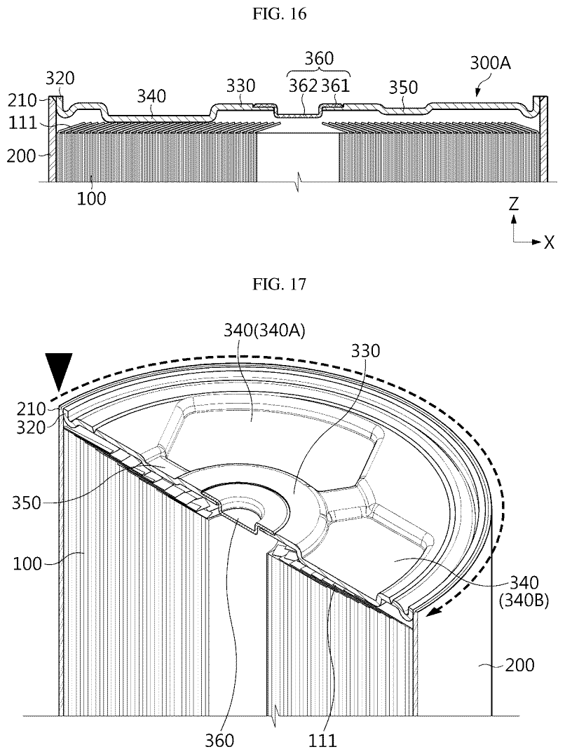

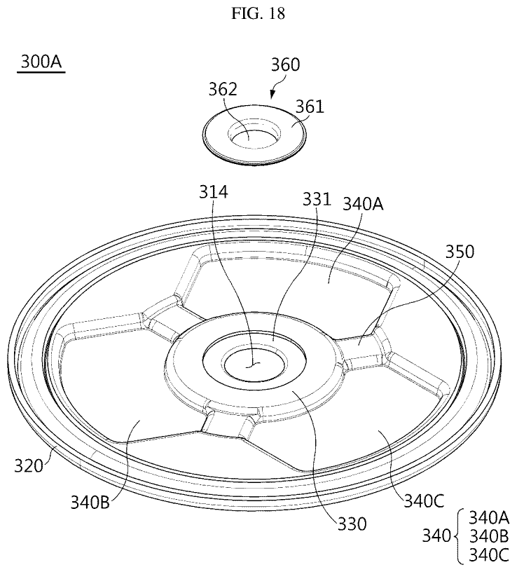

FIG. 16 is a cross-sectional view showing a portion of a battery cell according to a sixth aspect of the present disclosure, FIG. 17 is a perspective cross-sectional view of the battery cell of FIG. 16, and FIG. 18 is a perspective view of the housing lid of FIG. 17.

The battery cell according to the sixth aspect of the present disclosure includes a housing lid 300A having a U-shaped radially outer side 320, similar to the battery cell according to the fifth aspect described above.

That is, the radially outer side 320 may include, moving from the radially outer end of the housing lid 300A towards the radially inner side, the facing surfaces 321C, 322C, followed by the curved surface 323 (see FIG. 15). The facing surfaces 321C, 322C and the curved surface 323 may be configured to define an approximately U-shape. Laser welding W2 may be performed in the gap between the inclined portion 213 of the open end 210 and the first facing surface 321C of the radially outer side 320. The laser welding W2 may be performed continuously along the entire outer perimeter of the housing lid 300A in the circumferential direction of the battery housing 200.

In addition, referring to FIGS. 16 and 17, the housing lid 300A of the battery cell according to the sixth aspect of the present disclosure may include a lid core portion 330 positioned at the center portion of the housing lid 300A and convexly arranged upwardly so as to be spaced apart from the first uncoated portion 111 in the axial direction (Z direction). An electrode contact portion 340 configured to be in direct contact with the first uncoated portion 111 in the axial direction may be positioned between the lid core portion 330 and the radially outer side 320.

The electrode contact portion 340 may be coupled to the electrode assembly 100. Specifically, the bottom surface (the surface facing the electrode assembly 100) of the electrode contact portion 340 may be coupled to the contacting first uncoated portion 111 of the electrode assembly 100 by performing welding therebetween.

The electrode contact portion 340 may provide a planar bottom surface that extends in the radial direction. The height of the bottom surface of the electrode contact portion 340 may be lower than the bottom surface of the radially outer side 320. That is, the electrode contact portion 340 may protrude further downwardly toward the electrode assembly 100 than the radially outer side 320. As a result, the bonding process between the electrode contact portion 340 and the electrode assembly 100 may be smoothly performed.

As in the sixth aspect of the present disclosure, by coupling the electrode assembly 100 and the housing lid 300A so that the electrode contact portion 340 contacts the first uncoated portion 111, a separate welding process between a first current collector plate and the battery housing 200 may be omitted. Accordingly, due to the removal of the first current collector plate 400, the cost of parts may be reduced and the assembly process may be simplified.

The electrode contact portion 340 according to this aspect may be provided to be divided into three regions along the circumferential direction of the housing lid 300A, which is defined about the lid core portion 330 and/or the winding core center of the electrode assembly 100. That is, the electrode contact portion 340 of this aspect includes a first electrode contact portion 340A, a second electrode contact portion 340B, and a third electrode contact portion 340C, as shown in FIG. 18. Specifically, the three electrode contact portions 340A, 340B, 340C are discontinuous from one another and spaced apart by a predetermined interval along the circumferential direction. The three electrode contact portions 340A, 340B, 340C may be formed to be recessed further downwardly along the axial direction towards the electrode assembly 100 than the remaining portions of the housing lid 300A. As such, the electrode contact portions 340A, 340B, 340C may be configured to come into contact and electrical communication with the first uncoated portion 111. A bridge portion 350 is defined between each pair of adjacent electrode contact portions 340 along the circumferential direction. The bridge portion 350 is defined by a convex protrusion extending upwardly away from the electrode assembly 100, so as to be spaced apart from the first uncoated portion 111. As a result, each pair of adjacent electrode contact portions 340 are isolated from each other by a respective bridge portion 350. In this aspect, the number of the bridge portions 350 is three, and the three bridge portions 350 may be equally spaced apart along the circumferential direction with respect to the lid core portion 330. Successive bridge portions 350 may thus define angles of 120 degrees between them about the circumferential direction.

Although three electrode contact portions 340 and three corresponding bridge portions 350 are depicted in FIG. 18, in other aspects (not shown), more or fewer electrode contact portions and bridge portions may be provided. For example, preferred aspects in accordance with the present disclosure may provide arrangements of electrode contact portions with intervening bridge portions that have n-fold rotational symmetry about the lid core portion 330, where n is an integer of 3 or more.

According to the same configuration, sufficient adhesion may be provided between the housing lid 300A and the first uncoated portion 111 of the electrode assembly 100. In addition, if the internal pressure of the battery housing 200 increases beyond a threshold value, the three electrode contact portions 340A, 340B, 340C may become deformed convexly outward along the axial direction so as to become separated from the first uncoated portion 111. That is, when a significant thermal event occurs in the battery cell, the housing lid 300A may expand outward due to the internal pressure of the battery housing 200, and the electrode contact portions 340 may thus be separated from the first uncoated portion 111. As a result, the electrical connection between the battery housing 200 and the first electrode may be broken, thereby blocking the flow of current through the battery cell. In other words, a fuse-like function may be achieved by the above configuration.

Referring to FIGS. 16 to 18 again, the housing lid 300A according to this aspect further includes an electrolyte injection hole 314 and a plug cap 360 that seals the electrolyte injection hole 314.

The electrolyte injection hole 314 may be formed in the axial direction through the radially central region of the lid core portion 330.

The plug cap 360 may include a cap outer portion 361 facing the axially upper surface of the lid core portion 330 surrounding the electrolyte injection hole 314, and a cap center portion 362 defined by a shape that protrudes downwardly along the axial direction further than the cap outer portion 361.

The cap outer portion 361 may be seated on the housing lid 300A so as to face the stepped portion 331 defined on the lid core portion 330. In addition, the sealing force between the plug cap 360 and the housing lid 300A may be increased by welding the cap outer portion 361 and the lid core portion 330 together along the radially outer edge of the cap outer portion 361, such as by welding completely along the radial outer edge in the circumferential direction.

The cap center portion 362 may be configured to protrude downwardly in the axial direction from the cap outer portion 361 so as to be press-fitted into the electrolyte injection hole 314. That is, the cap center portion 362 may be configured to be press-fitted into the electrolyte injection hole 362.

When the plug cap 360 is seated on the housing lid 300A, the cap outer portion 361 extends from the electrolyte injection hole 314 in the radial direction of the lid core portion 330. The depth at which the cap center portion 362 is protrudes into the electrolyte injection hole 314 when press-fitted therein may thus be limited by the cap outer portion 361. In addition, the radially outer edge of the cap outer portion 361, where welding is performed, is spaced apart from the electrolyte injection hole 314 by a predetermined radial distance, so that interference with any electrolyte that may remain around the electrolyte injection hole 314 during welding may be minimized. The distance between the radially outer edge of the cap outer portion 361 and the radially outer edge of the electrolyte injection hole 314 may be in a range from 1.5 mm to 3.5 mm.

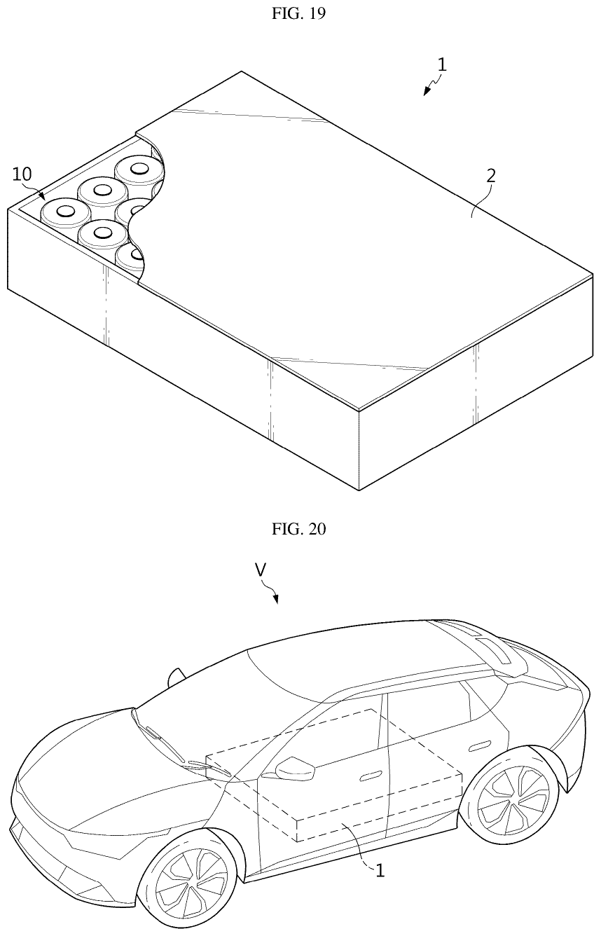

The battery cell as described above may be accommodated in the housing 2 of the battery pack 1, as shown in FIG. 19. The battery pack 1 may be configured using a battery module, which is an intermediate form of assembly. That is, multiple battery cells may be positioned within a battery module, and multiple such battery modules may be positioned within a battery pack 1. Alternatively, the battery pack 1 may be configured directly with multiple batter cells without the intervening battery modules, as illustrated. As in this aspect, the battery pack 1 in which the battery cells are accommodated directly in the housing 2 without intervening battery modules may result in a higher energy density than when battery modules are used.

The battery pack 1 having a high energy density as above may store the same amount of energy while reducing its volume and weight. Therefore, when the battery pack 1 including the battery cells 10 is installed in a vehicle such as the vehicle V, which uses electricity as an energy source, as shown in FIG. 20, the mileage of the vehicle per a given amount of energy may be further increased.

The vehicle V according to the first aspect of the present disclosure includes the battery pack 1 according to the first aspect of the present disclosure. The vehicle V may be configured to operate by receiving power from the battery pack 1 according to the first aspect of the present disclosure.

It should be understood that the above aspects are illustrative in all respects and not restrictive, and the scope of the present disclosure is to be determined by the appended claims rather than being limited by the detailed description set forth above. Furthermore, the meaning and scope of the appended claims, as well as all modifications and variations derived from their equivalents, should be construed as being included within the scope of the present disclosure.

Although the present disclosure has been described with reference to the accompanying drawings, the present disclosure is not limited to the aspects and drawings disclosed in this specification, and it would be understood that various modifications can be made by those skilled in the art within the scope of the technical ideas of the present disclosure. In addition, even if the effects according to the configurations of the present disclosure are not explicitly described while describing the aspects of the present disclosure, the effects that can be predicted by the configurations should also be acknowledged as being part of the present disclosure.

### REFERENCE SIGNS

10: battery cell 100: electrode assembly
111: first uncoated portion 121: second uncoated portion
200: battery housing 210: open end
211: first vertical portion 212: inclined portion
213: horizontal portion 214: second vertical portion
220: closed portion 223: insulating gasket
224: insulator 300: housing lid
310: lid center portion 312: vent notch
314: electrolyte injection hole 315: lid hole cap
320: radially outer side 321: first facing surface
322: second facing surface 330: lead core portion
340: electrode contact portion 350: bridge portion
360: plug cap 400: first current collector plate
410: plate center portion 411: center hole
420: plate outer portion 430: inclined connection portion
440: edge bent portion 500: second current collector plate
600: cell terminal

What is claimed is:

1. A battery cell comprising:
an electrode assembly in which a first electrode, a second electrode, and a separator interposed therebetween are wound around a winding axis;
a battery housing having a sidewall extending around a central axis between an open end and a closed end that oppose one another along the central axis, the open end defining an opening into an interior space of the battery housing bounded by an interior surface of the sidewall and accommodating the electrode assembly therein; and
a housing lid coupled to the open end of the battery housing so as to cover the opening,
wherein the interior surface of the sidewall along the open end has an inclined portion oriented obliquely relative to the central axis such that a cross-sectional area of the interior space of the battery housing defined orthogonally to the central axis decreases along the inclined portion away from the opening, and
wherein the housing lid includes a radially outer side defining a facing surface that contacts the interior surface of the sidewall at the open end, the facing surface extending longer than the inclined portion along an axial direction aligned along the central axis.

2. The battery cell according to claim 1,
wherein the open end includes:
a first axially-oriented portion of the interior surface;
the inclined portion of the interior surface, the inclined portion extending from an end of the first axially-oriented portion to the opening;
a lateral portion extending in a radially outward direction relative to the central axis, the lateral portion extending from an end of the inclined portion at the opening to a radially outer end; and
a second axially-oriented portion extending from the radially outer end of the lateral portion and defining an exterior surface of the sidewall.

3. The battery cell according to claim 2,
wherein the facing surface includes:
a first facing surface spaced from the inclined portion so as to define a gap between the inclined portion and the first facing surface; and
a second facing surface facing and contacting the first axially-oriented portion.

4. The battery cell according to claim 3,
wherein a welding bead is positioned in the gap between the inclined portion and the first facing surface.

5. The battery cell according to claim 2,
wherein the facing surface includes:
a first facing surface inclined to face and contact the inclined portion; and
a second facing surface facing and contacting the first axially-oriented portion.

6. The battery cell according to claim 2,
wherein the facing surface includes:
a first facing surface inclined along an angle relative to the central axis so as to face and contact the inclined portion; and
a second facing surface positioned closer to the closed end than the first facing surface, the second facing surface extending along the same angle as the first facing surface.

7. The battery cell according to claim 2,
wherein the inclined portion is configured to have an inclination angle relative to the central axis that decreases along the inclined portion away from the opening.

8. The battery cell according to claim 1,
wherein the inclined portion has a height along the axial direction in a range from 0.1 mm to 0.4 mm.

9. The battery cell according to claim 1,
wherein a ratio of a height of the inclined portion along the axial direction and a length of the facing surface of the radially outer side of the lid along the axial direction is in a range from 1:2.5 to 1:10.

10. The battery cell according to claim 2, further comprising:
a first current collector plate electrically connected to the first electrode inside the battery housing,
wherein the first current collector plate includes:
a plate center portion contacting a first uncoated portion extending from the first electrode;
a plate outer portion offset in the axial direction relative to the plate center portion so as to be spaced apart from the first uncoated portion, the plate outer portion extending radially outwardly from the plate center portion so as to contact the first axially-oriented portion of the interior surface; and
a peripheral portion extending from a radially outer end of the plate outer portion in contact with the first axially-oriented portion, the peripheral portion extending toward the housing lid at an oblique angle relative to the central axis.

11. The battery cell according to claim 10, further comprising:
a welding filler interposed in an open space bounded by the first axially-oriented portion of the interior surface of the sidewall, the peripheral portion of the first current collector plate, and the housing lid,
wherein the first axially-oriented portion, the peripheral portion, and the housing lid are welded together by the welding filler.

12. The battery cell according to claim 11,
wherein the welding filler is a metal material with a lower melting point than the battery housing, the first current collector plate, and the housing lid.

13. The battery cell according to claim 11,
wherein the welding filler is fixed inside the battery housing so as to prevent the housing lid from advancing further into the battery housing along the axial direction.

14. The battery cell according to claim 1, further comprising:
a first current collector plate disposed between the electrode assembly and the housing lid inside the battery housing and electrically connected to the first electrode,
wherein the housing lid has an electrolyte injection hole at a center thereof,
wherein the first current collector plate has a center hole aligned with the electrolyte injection hole along the central axis, and
wherein a cavity at a winding core center of the electrode assembly is aligned with the center hole along the central axis.

15. The battery cell according to claim 1,
wherein the radially outer side of the housing lid defines a ‘U’ shape.

16. The battery cell according to claim 1,
wherein the housing lid includes a lid center portion positioned radially inwardly from the radially outer side of the lid, the lid center portion being in direct contact with a first uncoated portion extending from the first electrode.

17. The battery cell according to claim 1,
wherein the housing lid includes:
a lid core portion positioned at a central portion of the housing lid in a radial direction with respect to the central axis, the lid core portion defining a convex surface facing the electrode assembly, the convex surface of the lid core portion being arranged so as to be spaced apart from the first uncoated portion in the axial direction; and
an electrode contact portion positioned between the lid core portion and the radially outer side of the lid in the radial direction, the electrode contact portion being in direct contact with the first uncoated portion in the axial direction.

18. The battery cell according to claim 17,
wherein the electrode contact portion is divided into three regions spaced apart from one another in a circumferential direction about the central axis.

19. The battery cell according to claim 17,
wherein the lid core portion has an electrolyte injection hole formed therethrough along the axial direction,
wherein the housing lid further includes a plug cap that covers the electrolyte injection hole, and
wherein the plug cap includes a cap outer portion overlying a surface of the lid core portion extending around a periphery of the electrolyte injection hole, and a cap center portion protruding from the cap outer portion through the electrolyte injection hole along the axial direction and into the battery housing.

20. The battery cell according to claim 19,
wherein a radially outer edge of the cap outer portion is spaced radially away from a radially outer edge of the electrolyte injection hole by a distance in a range from 1.5 mm to 3.5 mm, and
wherein the cap outer portion and the lid core portion are welded together.

21. A battery pack comprising at least one battery cell according to claim 1.

22. A vehicle comprising the battery pack according to claim 21.
